(19) United States
(12) Patent Application Publication
(10) Pub. No.: US 2023/0237187 A1
(43) Pub. Date: Jul. 27, 2023

(54) MANAGING ACCESS TO PHYSICAL ASSETS BASED ON CAPTURED DIGITAL DATA AND A DATABASE

(71) Applicants: Candice Lin, Cupertino, CA (US); Phuc Nguyen, San Jose, CA (US); Kaoru Watanabe, Sunnyvale, CA (US); Te-Yu Chu, San Jose, CA (US); Yuwen Wu, Cupertino, CA (US); Shun Tanaka, Parsippany, NJ (US); Jayasimha Nuggehalli, Cupertino, CA (US)

(72) Inventors: Candice Lin, Cupertino, CA (US); Phuc Nguyen, San Jose, CA (US); Kaoru Watanabe, Sunnyvale, CA (US); Te-Yu Chu, San Jose, CA (US); Yuwen Wu, Cupertino, CA (US); Shun Tanaka, Parsippany, NJ (US); Jayasimha Nuggehalli, Cupertino, CA (US)

(73) Assignee: Ricoh Company, Ltd., Tokyo (JP)

(21) Appl. No.: 17/583,076

(22) Filed: Jan. 24, 2022

(51) Int. Cl. G06F 21/62; G06V 30/418; G06F 16/38

(52) U.S. Cl. CPC G06F 21/6227; G06V 30/418; G06F 16/381; G06F 2221/2141

(57) ABSTRACT

Techniques for managing access to physical assets based on captured digital data and a database are provided. In one technique, one or more functions in an application that executes on a client device are locked. A smart badge that is associated with healthcare information is then received from a remote server system. In response to receiving the smart badge, the one or more functions are unlocked. After unlocking the one or more functions and in response to user input that selects a particular function of the one or more functions, a request and identification data that pertain to the particular function are transmitted over a computer network.

### CROSS-REFERENCE TO RELATED APPLICATIONS

This application is related to U.S. patent application Ser. No. 17/515,023, filed Oct. 29, 2021, the entire contents of which are hereby incorporated by reference as if fully set forth herein.

### TECHNICAL FIELD

The present disclosure relates generally to improving the management of access to one or more physical areas and, more particularly to, managing access to a physical area by using captured physical document data and a database and modifying a client functionality or server functionality.

### BACKGROUND

Managing access to buildings, rooms, etc., (referred to herein as “physical areas”) has been addressed with modern key card access systems. After being issued a key card (e.g., with radio-frequency identification (RFID) technology), a person may present the key card at a card reader adjacent to a physical area in order to gain physical access to that physical area. If the card reader recognizes an identifier transmitted from the key card, then the person is granted access, which may be in the form of automatically unlocking a door.

However, there is a growing need to add further restrictions to accessing physical areas, particularly in the area of preventing the transmission of communicable diseases. Issuing and deactivating key cards based on the health or vaccination status of an individual quickly becomes an administrative burden, especially for large enterprises.

One approach is for all people who wish to gain access to certain physical areas to travel to certain designated areas where one or more checks are performed, such as checking a vaccination card and performing a temperature test. For example, a person with a temperature within a certain range is granted access to a physical area by the person administering the temperature test. However, this approach is a significant administrative burden that increases the costs of running an enterprise. Also, this approach requires people to administer the checks near the entrance of each physical area when there may be many physical areas to which a person might need access. Furthermore, if a person needs access to one or more of the physical areas on a daily basis, then these checks need to be performed manually on a daily basis.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIGS. 1A-1B are block diagrams that depict an example system for extracting data from image data, securely storing the extracted data, and granting access to a physical area, in an embodiment;

FIG. 2 is a flow diagram that depicts an example process for providing encoded data to a user's computing device, in an embodiment;

FIG. 3 is a flow diagram that depicts an example process for securely granting access to a physical area, in an embodiment;

FIG. 4 is a sequence diagram that depicts an example process for unlocking one or more client-side functions in response to receiving a smart badge, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for managing user access to physical areas are provided. In one technique, one or more functions in a client (e.g., mobile) application are locked. A client device on which the client application executes receives, a smart badge from a remote server system. In response to receiving the smart badge, the one or more functions are unlocked. Afterwards and in response to receiving user input that selects a particular function of the one or more functions, the client device transmits, over a computer network, a request and identification data that pertain to the particular function. An example of the particular function is a reservation function that triggers a reservation process to reserve a room in a building or a seat in an auditorium.

Embodiments improve computer-related technology by unlocking client-side functionality based on server-side activity. Once unlocked (e.g., due to issuance of a smart badge), a user of the client-side application may utilize the unlocked functions, such as reserving a physical asset or printing electronic document data. In this way, operations related to physical assets may be controlled automatically based on verified health information.

In another technique, a server system receives, from a client device, a first reservation request to reserve a location for a user of the client device. If a user identifier in the reservation request is not in a particular database, then the reservation request is denied. The user identifier is not in the particular database if the user did not provide valid health information to the server system. Otherwise, the reservation request is accepted.

Embodiments improve computer-related technology by modifying server-side functionality to enforce health status checking separate from a client device. In this way, a client-side application does not have to change. The server system essentially unlocks certain functions requested by the client device based on whether valid health information has already been received for a user of the client device.

### System Overview

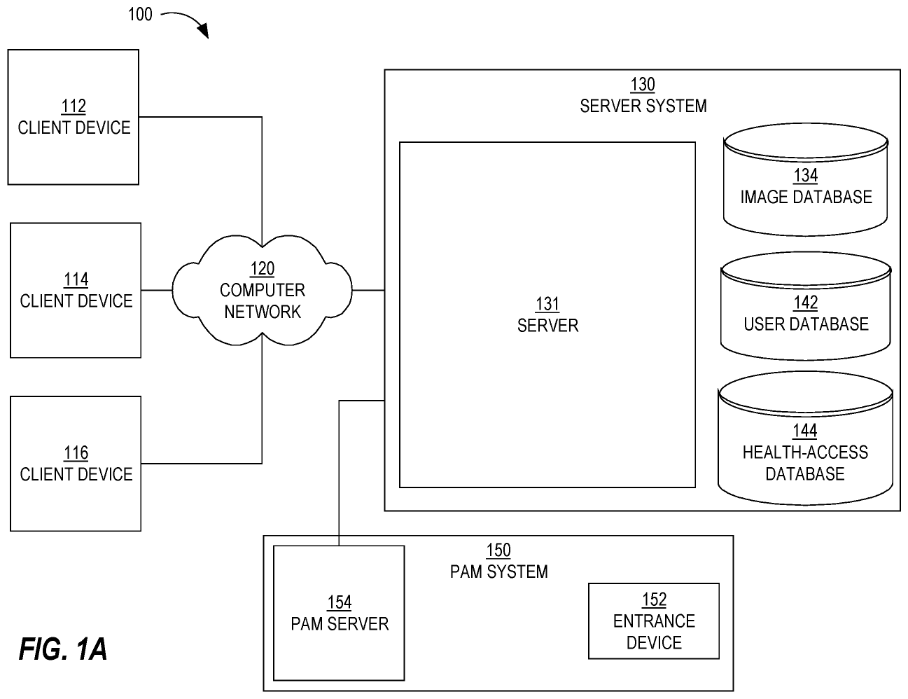

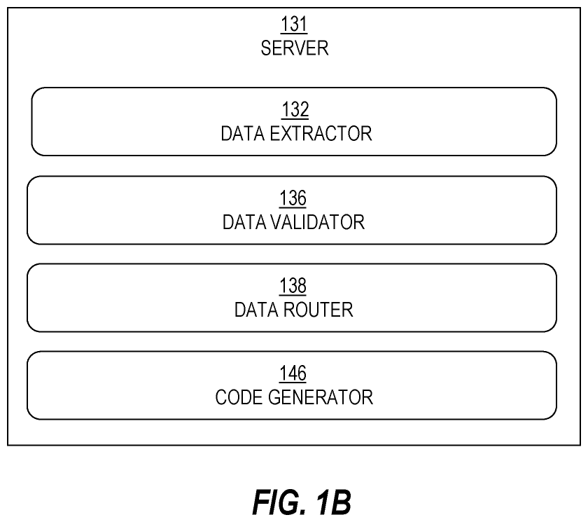

FIG. 1A is a block diagram that depicts an example system 100 for extracting data from image data, securely storing the extracted data, and granting access to a physical area, in an embodiment. System 100 includes client devices 112-116, a computer network 120, a server system 130, and a physical access management system 150.

Client devices 112-116 are communicatively coupled to server system 130 via computer network 120 (e.g., a LAN, WAN, or the Internet). Examples of client devices 112-116 include desktop computers, scanning devices, video game consoles, and mobile devices, such as laptop computers, tablet computers, wearable devices, and smartphones.

One or more of client devices 112-116 may include a digital camera that “takes pictures” or, in other words, generates digital images. The digital images may be in any image format, such as TIFF, GIF, PNG, RAW, PDF, and JPEG. One or more of client devices 112-116 may execute a software application that includes a software application that is configured to communicate with server system 130. For example, the software application may be developed by the entity that owns or operates server system 130. The software application is configured to communicate with the host device's camera. Through the software application, a user of the client device points the camera view toward a physical document, such as vaccination card or a document indicating the results of one or more medical tests, such as a (polymerase chain reaction) PCR test. One or more client devices may scan the vaccine card, a document indicating the results of one or more medical tests, or other document for entering the physical area. Additionally or alternatively, one or more client devices may just send a digital file to server system 130. This may be the case, for example, when a government provides a vaccine card as a digital file.

### Server System

As depicted in FIG. 1A, server system 130 includes a server 131, an image database 134, a user database 142, and a health-access database 144.

As depicted in FIG. 1B, server 131 comprises a data extractor 132, a data validator 136, a data router 138, and a code generator 146. Server system 130 may include multiple servers. For example, each of data extractor 132, data validator 136, data router 138, and code generator 146 may be implemented in a different server. Each of data extractor 132, data validator 136, data router 138, and code generator 146 may be implemented in software, hardware, or any combination of software and hardware.

Although depicted as functioning separately, two or more of data extractor 132, data validator 136, data router 138, and code generator 146 may be implemented in the same computing component (e.g., software program). The function of data validator 136 is optional.

Although the elements of server system 130 are depicted as being the only element of its kind in server system 130, server system 130 may include multiple of one or more of these elements, such as multiple user databases and multiple data validators. These additional elements may be mirrored versions of the original elements in order to provide backup in case the corresponding elements fail. Additionally or alternatively, if there are multiple user databases, then each user database may contain information about a different set of users, each set of users corresponding to a different organization or enterprise. For example, one user database contains information about employees from company A while another user database contains information about employees from company B.

Additionally, system 100 may include multiple server systems 130.

### Data Extractor

Data extractor 132 receives image data from a client device (e.g., client device 112). Data extractor 132 extracts information from the image data. For example, data extractor 132 performs optical character recognition (OCR) on the image data. Data extractor 132 may store image data in a record of image database 134, which is optional. Each record in image database 134 may include a record identifier, image data, the extracted data for that image data, a device identifier (e.g., an IP address or a MAC address) that identifies a device that transmitted the image data to server system 130, and/or a user identifier (e.g., an employee identifier) that identifies a user that operated the device or was logged into the device when the device transmitted the image data.

While data extractor 132 is depicted as executing in server system 130, a portion of data extractor 132 may execute in a client device, such as client device 112. For example, an OCR function may be executed in the client device. Data extractor 132 extracts predetermined data (e.g., first name, last name) from a digital file (e.g., a digital image). Data extractor 132 may extract predetermined data according to a parsing rule.

In embodiment, one or more parsing rules are defined to sample data from a sample image. For example, one parsing rule is used to extract a last name, while another parsing rule is used to extract a first name. After the parsing rules are defined, portions of an instance of image data are automatically extracted using the one or more parsing rules. A description of implementing parsing rules is found in the following related applications: U.S. patent application Ser. Nos. 16/805,663 and 16/587,418.

In an embodiment, data extractor 132 generates a confidence level of each extracted data item from the image data. The confidence level indicates how confident data extractor 132 is in extracting correct text and in associating that text with an appropriate field name, such as Last Name, Vaccination Date, etc. Thus, data extractor 132 may assign a high confidence level to extracting “Davis” but assign a low confidence level in associating “Davis” to any of the available data fields, such as Last Name and First Name.

In an embodiment, in addition to image data, client device 112 transmits an identifier that uniquely identifies the user of client device 112. For example, if client device 112 executes a software application that is registered with the entity that owns or manages the data in user database 142, then the software application includes a user identifier or device identifier that is included in one of the records in user database 142. Thus, data extractor 132 may also store the identifier in the record that includes the corresponding image data.

### Data Validator

Data validator 136 (which is optional) validates data that data extractor 132 extracted from image data. For example, data validator 136 validates whether a set of predefined field names have been extracted along with corresponding values: last name, first name, a date, a recognized vaccine type, a vaccination location, a lot number, and/or a clinic site. If a predefined field name has not been extracted, then data validator flags the extracted data (and/or the corresponding image data). “Flagging” involves storing data that indicates that the extracted data is incomplete. Similarly, if a value for a predefined field name has not been extracted, then data validator 136 flags the extracted data (and/or the corresponding image data). A reason why predefined field names and/or corresponding values might not be extracted by data extractor 132 is because the names or values may be unrecognizable due to poor penmanship, folds in the physical document that obscure some letters, and physical wear from sunlight or liquids.

In an embodiment, an administrator device (not depicted) has access to image data and corresponding extracted data in order to manually validate extracted data. A user of the administrator device may limit manual validations to image data that has been flagged. In this way, relatively few manual validations may need to be made.

In a related embodiment where a confidence level is determined for each of one or more extracted data items (i.e., field names and corresponding values), data validator 132 determines, based on a confidence value of an extracted data item, whether to store notification data and/or send a notification message to an account associated with an administrator user or to the administrator device. For example, if a confidence level of a particular extracted data item is less than a predefined confidence threshold, then data validator 132 sends a notification message to the administrator device. A user of the administrator device logs into server system 130 and accesses image database 134 to view the image data in conjunction with any extracted data items.

### Data Router

Data router 138 receives extracted data that has been validated. Data router 138 may receive the extracted data directly from data validator 136 or from image database 134. For example, data router 138 periodically checks image database 134 for new or updated records. Each record may include a field value that indicates whether the corresponding extracted data is complete or has the necessary information to confirm that the corresponding user has passed a health check or been vaccinated. As another example, data validator 136 sends a row identifier to data router 138 when data validator 136 determines that the extracted data is complete. Receipt of the row identifier triggers data router 138 searching user database 142. In this way, data router 138 is not required to periodically search image database 134.

Data router 138 searches for a record in user database 142, which stores data about multiple users. For example, user database 142 may be an employee database that stores data about multiple employees of an enterprise or company. The search criteria that data router 138 uses to search user database 142 may include a user identifier, a device identifier, a last name, and a first name. If an identifier is used to search user database 142, then no other search criteria may be required to search user database 142 since the identifier may be uniquely identifying, such as a device identifier or an employee identifier. If an identifier is not available, then data router 138 may use last name and first name as search criteria to search user database 142.

Data router 138 generates association data and stores the association data in an appropriate record in health-access database 144 when data router 138 identifies a corresponding record in user database 142 based on the extracted data. As described in more detail herein, data router 138 may store the user/employee identifier to the record of health-access database 144. In this case, the user/employee identifier (which is found in user database 142 and stored in a record of health-access database 144) is the association data. The generation of the association data and storing the association data are associating the extracted data with the user/employee identifier.

If contents of health-access database 144 are stored in image database 134 (as described in more detail herein), updating one or more fields of a corresponding record in the image database 134 with data from user database 142 is the “associating.” In this case, the updated data of the field is the association data. In other words, any data that associates user/employee data with the extracted data can be the association data.

Health-access database 144 includes, for each record, (1) extracted data, i.e., data that has been extracted from image data and (2) data from user database 142. Thus, each record in health-access database 144 includes data items from corresponding image data (e.g., a first name, a last name, a date of a vaccination, a type of vaccine, a location of the vaccination) and one or more data items from user database 142 (e.g., a user/employee identifier, authorized physical areas, times of authorized access). A user identifier (from user database 142) in a record of health-access database 144 allows a lookup into user database 142 given a record in health-access database 144.

A record in health-access database 144 may be updated in response to an update to a corresponding record in user database 142. For example, if an employee leaves the company, then the corresponding record in user database 142 may be deleted (or updated to indicate the departure). Also, the corresponding record in health-access database 144 is similarly deleted or updated.

Although health-access database 144 is depicted as a separate database from user database 142, the data in health-access database 144 may be stored in user database 142. For example, user database 142 may be updated to include one or more fields for extracted data, such as date of a vaccination, type of vaccine, and location of the vaccination. Alternatively, the data in health-access database 144 may be stored in image database 134. For example, image database 134 may be updated to include one or more fields for the extracted data and employee identifier, email address, and/or phone number, which originates from user database 142.

In some situations, a record in user database 142 might not be found based on extracted data. This may result from at least a portion of the extracted data being inaccurate (e.g., last name of “Smith” is extracted as “Smyth”) or from an incomplete user database 142. If a matching record is not found, then data router 138 may cause a notification message to be transmitted to the client device that transmitted the corresponding image data. Additionally or alternatively, data router 138 may cause a notification message (e.g., a SMS message, an email message, or an app message) to be transmitted to a computing device of an administrator user of server system 130. Upon user selection of a link in the notification message, server system 130 presents at least a portion of (1) the extracted data and (2) the image data on a screen of the computing device. GUI controls may be included in the presentation to allow the administrator user to modify the extracted data if the administrator user determines that the extracted data does not match corresponding data reflected in the image data. For example, the administrator user may type in a last name that is different than the last name that data extractor 132 detected.

### Code Generator

Code generator 146 generates a code for a new record in health-access database 144 or for extracted data that has been validated. The code (or an encoded version thereof) is eventually transmitted to a device of a user, who will present the code (or the encoded version) to a code reader that is adjacent to an entrance of a physical area to which the user seeks access. Thus, the code may be tied or linked to the new record in health-access database 144 (or to the appropriate record in user database 142). Alternatively, the code may be a particular value that affirms that the associated user has passed a health check, such as receiving a vaccination or passing a medical test, such as a PCR test that tests whether the user is infected with a particular virus.

In an embodiment, code generator 146 generates a code using one or more encoding techniques. Example encoding techniques include a bar code generation technique, a two-dimension code generation technique (e.g., a QR code generation technique), and encryption, such as public-private key encryption. In the latter scenario, code generator 146 uses a private key to encrypt the code, resulting in encoded data.

After a code is generated, the code (or an encoded version thereof) is transmitted over computer network 120 to a client device, such as client device 112. Transmission of the code (or encoded data) may be performed by code generator 146 or another element of server system 130.

Transmission of the code (or encoded data) may be performed in one of multiple ways. For example, a text message (that includes the encoded data) is transmitted based on a phone number that is retrieved from the matching data item located in user database 142. As another example, an email message (that includes the encoded data) is generated and sent to an email address that was retrieved from the matching data item. As another example, an application message is sent to an application that is executing on the client device. The application or client device is identified based on an identifier for the client device, where the identifier is retrieved from the data item.

The client device that receives the code/encoded data may be a mobile device that transmitted the image data, which resulted in server system 130 extracting data from the image data, identifying a record in user database 142 based on the extracted data, and generating the code in case a record in user database 142 is found. If the code is a value that indicates that the corresponding user is granted access to a physical area, then the code may be sent to PAM system 150, which is described in more detail herein.

### Code Generation Process Overview

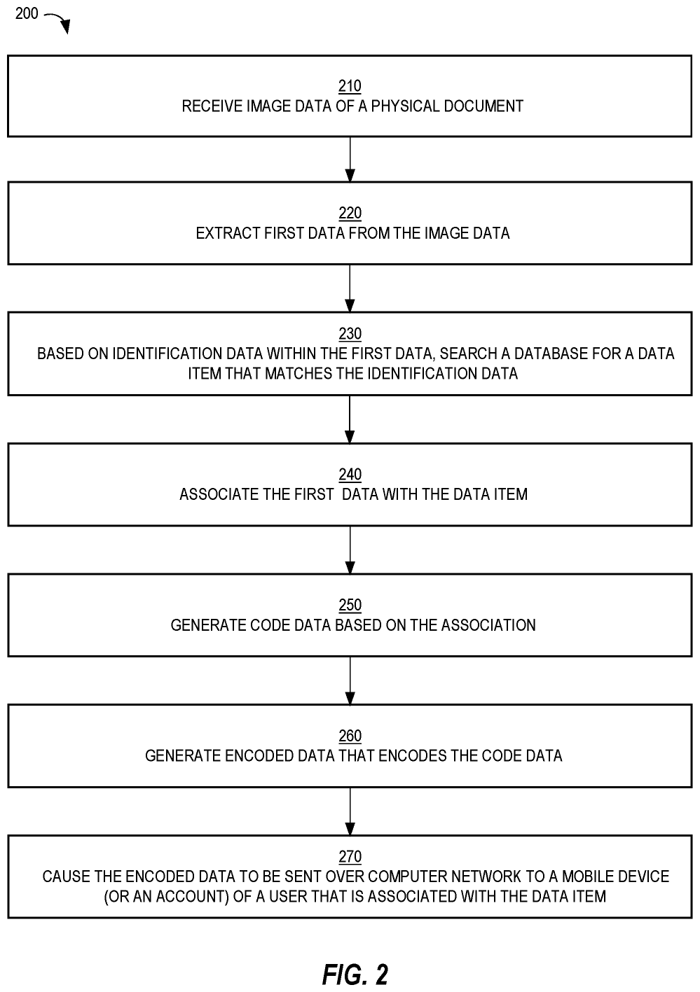

FIG. 2 is a flow diagram that depicts an example process 200 for providing encoded data to a user's computing device, in an embodiment. Process 200 may be performed by different elements of server system 130.

At block 210, image data of a physical document is received, such as over computer network 120. Block 210 may involve receiving the image data from a mobile device, such as client device 112, that includes a digital camera that generated the image data. Alternatively, the physical document may have been scanned by a scanning machine that is communicatively coupled to server system 130.

At block 220, first data (referred to as “extracted data”) is extracted from the image data. The extracted data includes information reflected on the physical document, such as one or more names of an individual and one or more health-related items. Block 220 may be performed by data extractor 132, which implements one or more OCR techniques.

At block 230, based on identification data within the extracted data, a database is searched for a data item that matches the identification data. Block 230 may be performed by data router 138. The identification data may be a first name and a last name. Alternatively, the identification data may be a user/employee identifier, which may or may not be separate from the extracted data.

At block 240, the extracted data is associated with the data item. Block 240 may involve generating data that associates with extracted data with the data item. The generated data may be a user/employee identifier that is associated with both the extracted data and the data item. The generated data essentially links the extracted data with the data item in the database.

At block 250, code data is generated based on the association data. The code data may include (a) a portion of the extracted data, such as some of the vaccination-related data; (b) a randomly-generated number that is unique to the corresponding user; and/or (c) a value that indicates that the user is authorized access to one or more physical areas.

At block 260, encoded data that encodes the code data is generated. The encoded data may be a QR code, a bar code, or a series of alphanumeric characters that is a result of encrypting the code data using an encryption key.

At block 270, the encoded data is caused to be sent, over a computer network, to a mobile device, or an account, of a user that is associated with the data item. Block 270 may involve sending the encoded data to a particular software application executing on the mobile device, where the particular software application is a native application that is configured to communicate with server system 130.

### Physical Access Management System

Physical access management (PAM) system 150 manages, in conjunction with server system 130, physical access to one or more physical areas. PAM system 150 includes an entrance device 152 and a PAM server 154 to which entrance device 152 is communicatively coupled. Although only one entrance device is depicted, PAM system 150 may include multiple entrance devices.

Entrance device 152 is physically located near an entrance to a physical area to which a person may seek access. The entrance to the physical area may include a door, gate, or other object to prevent access to the physical area. The entrance may include a locking mechanism that locks the entrance (or otherwise prevents a person from entering the physical area). The locking mechanism unlocks the entrance based on data received from entrance device 152, as described in more detail below.

Entrance device 152 includes a code reader, such as a bar code reader or a QR code reader, that reads encoded data that is presented on a screen of client device 112. Additionally or alternatively, entrance device 152 includes a radio frequency (RF) receiver that receives an RF transmission from client device 112, which is configured to transmit the encoded data based on the encoded data that client device 112 received from server system 130. If a user is granted access, then a message is sent to the locking mechanism of the entrance to cause the entrance to be unlocked. This message may be sent by entrance device 152, PAM server 154, or server system 130.

In an embodiment, PAM system 150 is communicatively coupled to server system 130. For example, PAM server 154 is communicatively coupled to code generator 146 and/or data router 138. PAM server 154, upon receiving encoded data from entrance device 152, may communicate with data router 138 to verify that the encoded data is valid. Data router 138 (or another component of server system 130) decodes the encoded data and searches health-access database 144 based on the decoded data, searching for a matching data item. If a matching data item exists, then data router 138 informs PAM server 154.

In an alternative embodiment, instead of communicating with server system 130 to determine whether to grant access to the requesting user/client device, PAM server 154 receives a code from entrance device 152 and PAM server 154 makes a decision based on the code alone.

In an embodiment where the encoded data is an encrypted code data, PAM server 154 uses a public key to decrypt the encrypted code data to generate the original code data. PAM server 154 then makes a decision regarding whether to grant, to a user that presented the encoded data to entrance device 152, access to a physical area.

In the other non-encryption encoding techniques, PAM server 154 is able to decode the encoded data without a decryption key, such as using a bar code reader or a QR code reader to decode the encoded data.

In response to determining to grant access to a user that presents the encoded data to entrance device 152, PAM server 154 sends, to entrance device 152, a message indicating the grant. Entrance device 152, in turn, communicates with a locking mechanism of the entrance to cause the entrance to be unlocked. For example, the locking mechanism could be a bolt that extends from a door to a wall that is adjacent to the door. The locking mechanism causes the bolt to retreat inside the door, allowing a person to open the door without the bolt blocking the opening thereof.

### Physical Access Grant Process Overview

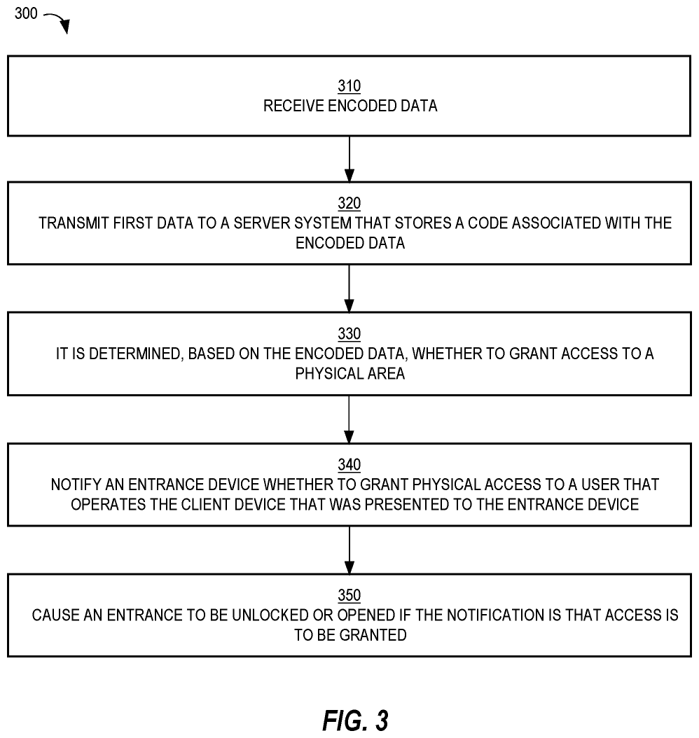

FIG. 3 is a flow diagram that depicts an example process 300 for securely granting access to a physical area, in an embodiment. Process 300 may be performed by different elements of PAM system 150 and, optionally, of server system 130.

At block 310, encoded data is received. Block 310 may involve entrance device 152 reading encoded data that is presented on a screen of client device 112 or that is printed on a physical document. For example, a user provides, to client device 112, input (e.g., selection of one or more graphical buttons) that causes the encoded data to be presented on the screen. As another example, the user provides input that causes client device 112 to transmit a radio signal (that encodes the encoded data) that entrance device 152 is able to receive and process. As another example, a user presents a printed QR code (e.g., on paper) at an entrance device 152. Block 310 may also involve entrance device 152 sending the encoded data to PAM server 154.

At block 320, first data is transmitted to a server system (e.g., server system 130) that stores a code that is associated with the encoded data. The first data may be the encoded data or a decoded version of the encoded data. For example, in block 260, data router 138 encrypts the code that is generated with an encryption key. In this example, either PAM server 154 (a) decrypts the encrypted code and sends the decrypted code to server system 130 or (b) sends the encrypted code to server system 130. If the latter, then the encryption key may be a symmetric key, which server system 130 uses to decrypt the encrypted code; otherwise, the encryption key is a private key and PAM server 154 has a public key to decrypt the encrypted code. As another example, the encoded data is a QR code that entrance device 152 reads/decodes and sends to server system 130.

At block 330, it is determined whether to grant access to a physical area based on the encoded data. Block 330 may involve server system 130 first decoding the encoded data if PAM system 150 (e.g., entrance device 152) has not already done so. Block 330 may involve server system 130 looking up a corresponding record in health-access database 144 based on the decoded data.

At block 340, entrance device 152 is notified whether to grant access (to a physical area) to a user that operates the client device that was presented to entrance device 152. Block 340 may involve server system 130 transmitting grant data to PAM server 154, which determines a type of signal to transmit to entrance device 152 based on the content of the grant data.

At block 350, entrance device 152 causes an entrance to be unlocked or opened if the notification is that access is to be granted.

In process 300, server system 130 is involved. However, PAM system 150 may perform all the steps of receiving the encoded data, decoding the encoded data, and determining whether to grant physical access based on the decoded data. This is possible if server system 130 (e.g., data router 138) provides access data (e.g., a record from health-access database 144) to PAM system 150 upon generation of a code for a user and/or the user's computing device.

### Unlocking Client-Side Functions

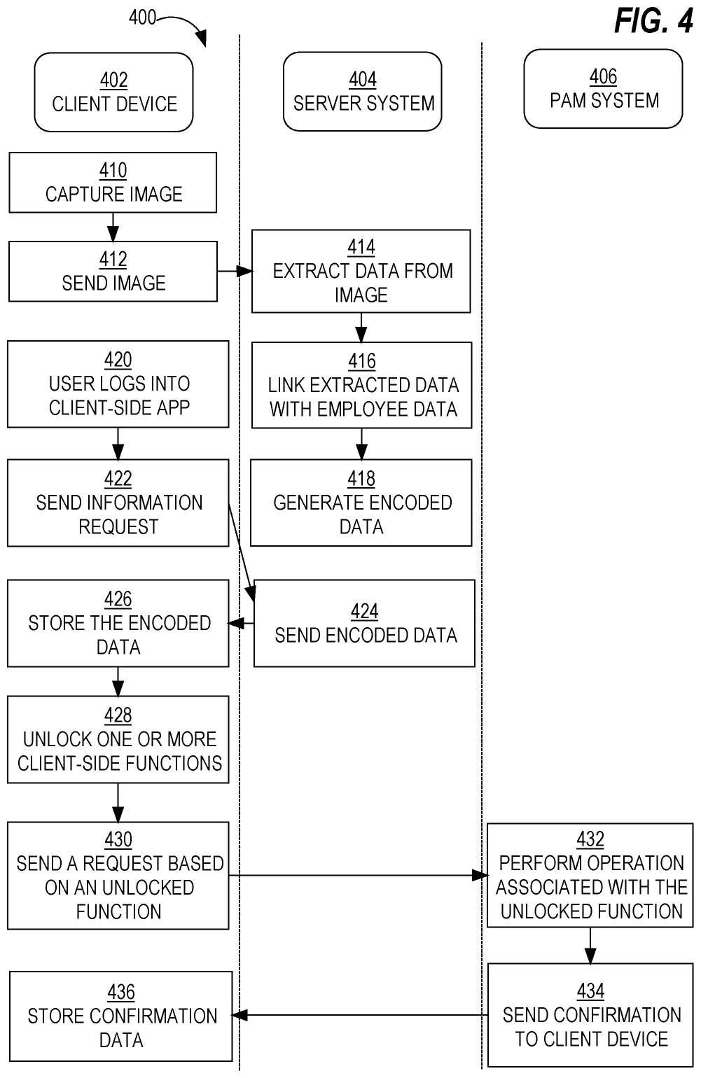

FIG. 4 is a sequence diagram that depicts an example process 400 for unlocking one or more client-side functions in response to receiving a smart badge, in an embodiment. FIG. 4 includes a representation of three different components or elements: a client device 402 (e.g., client device 112), a server system 404 (e.g., server system 130), and a physical access management system 406 (e.g., PAM system 150). PAM system 406 may including multiple systems. For example, a different PAM system may be used for each function. One of the one or more PAM systems may be third party system. One of the one or more PAM systems may communicate with the client device 402 by using an API. Client device 402 executes a software application that receives (e.g., from server system 130), stores, and presents (e.g., to entrance device 152) encoded data, such as a QR code.

At step 410, client device 402 captures image data pertaining to a health card, such as a vaccination or immunization card. At step 412, client device 402 sends the image data to server system 404. Alternatively, an entity other than client device 402 may capture the image data and send the image data to server system 404.

At step 414, server system 404 extracts data from the image data. Step 414 may involve optical character resolution (OCR).

At step 416, server system 404 links the extracted data with employee data. Step 416 may involve (1) identifying an entry or row in an employee database based on the extracted data, (2) creating an entry or row in an immunity database, and (3) including, in that entry/row, an employee identifier (ID) of the entry/row identified in the employee database.

At step 418, server system 404 generates encoded data, such as a QR code. The encoded data may be considered a “smart badge.” The encoded data may be include an employee ID, a user ID, a device ID, and/or a randomly-generated value that is associated with the user of client device 402.

At step 420, a user logs into a client-side application executing on client device 402. The login may include user credentials, such as a username and password, an example of which is an employee ID. Step 420 may occur before or after step 418.

At step 422, client device 402 sends, to server system 404, a request for an information update. This request may be initiated by the client-side application and may be sent automatically in response to the user logging into the client-side application. Alternatively, the request may be sent in response to the client-side application receiving user input from the user after the user logs into the client-side application.

At step 424, server system 404 sends the encoded data to client device 402. Step 424 may be performed in response to receiving the request sent in step 422. Alternatively, step 422 is unnecessary and step 424 occurs automatically after step 420.

At step 426, client device 402 stores the encoded data (or “smart badge”). Step 426 may involve storing the encoded data in a portion of local storage (i.e., on client device 402) that is accessible to, and associated with, the client-side application.

At step 428, the client-side application is updated to unlock one or more functions. An example function that may be in a locked state is a reservation function that allows a user to reserve, using the client-side application, a room, seat, or other defined physical area. Prior to step 426, the one or more functions are locked (or in a locked state). Thus, the receipt of the encoded data (or “smart badge”) triggers the unlocking of the one or more functions (or changing the state of the one or more functions from a locked state to an unlocked state). Other example functions include utilizing a printer, a scanner, or other hardware or software component available in a physical area to which the smart badge is grants the user access.

A locked function may be presented in one or more ways on client device 402. For example, a button (for reserving a room) that is included in a graphical user interface (GUI) (that is presented, by the client-side application, on a screen of client device 402) is presented differently than other buttons that are included in the GUI. For example, buttons corresponding to locked functions are grayed while buttons corresponding to unlocked functions have a clear, white background. Alternatively, a lock function has no corresponding button in the GUI. Then, when the function is unlocked, a corresponding button appears in the GUI.

Instead of a button, a function may be listed in a menu. Again, the name of a locked function may be grayed out or not appear in the menu. There are numerous ways in which an unlocked function may appear differently than a locked function. In response to a user's action relative to a locked function (e.g., touching or pushing the button of the locked function, or another action), client device 402 may prompt the user of client device 402 to take a picture of a health (e.g., vaccination) card (e.g., by causing prompt data to be presented on a screen of client device 402 or by causing audio data to be played that prompts the user to take the picture), which picturing taking may trigger the automatic transfer of the resulting digital image to server system 404.

At step 430, client device 402 generates and sends, to PAM system 406, a request. If the function is a reservation function, then the request is a reservation request to reserve a physical asset, an example of which includes a pre-defined physical area, such as a room or seat. Step 430 may be performed in response to user input received through the client-side application, such as selecting a button or a listed name (e.g., in a GUI) corresponding to an unlocked function. For reservation requests, such a request may include an ID that uniquely identifies the physical asset and an ID that uniquely identifies the user or client device.

At step 432, PAM system 406 may perform different operations depending on the type of request that client device 402 sends. For example, in response to receiving a reservation request, PAM system 406 stores reservation data that indicates that the identified physical asset or area is reserved. The reservation data may include a physical asset ID that was included in the reservation request, a user/employee ID that was also included in the reservation request, and a date and time of the reservation. Step 432, in this example, may involve multiple back and forth messages between PAM system 406 and client device 402 to allow a user of client device 402 to select an available physical asset (e.g., from among multiple physical assets) at an available date and time period.

As another example, in response to receiving a print request from client device 402, PAM system 406 generates a new print request and includes items from the original print request (e.g., document data that is to be printed on a physical medium, user identification data that identifies a user of client device 402, a password to enter at a printing device to unlock the print function of the printing device) into the new print request that an available printing device can process. Step 432, in this example, would also involve transmitting the new print request to the available printing device. The original print request may include printing device identification data that identifies a particular printing device that the user of client device 402 selected through the client-side application.

At step 434, PAM system 406 sends confirmation data to client device 402. The confirmation data indicates whether the requested function or operation has been performed. For example, if the function is a reservation function, then the confirmation data identifies the physical asset that has been reserved, a user of client device 402, and a date and time of the reservation. As another example, if the function is a print function, then the confirmation data identifies a printing device that has or will perform the print function and, optionally, a location of the printing device and any credentials needed to unlock the printing device in order for the printing device to print a requested document.

At step 436, client device 402 stores the confirmation data. This storing step allows a user of client device 402 to view (through navigating a GUI presented by the client-side application) any confirmed reservations, print jobs, etc. In the context of reservations, at some times, a user may have multiple current reservations of physical assets on the same day and/or different days.

### Server-Side Modification

In an embodiment that is related but different than unlocking client-side functions, the client-side application presents all functions, whether currently available or not. Thus, the functions may appear in an unlocked state to a user of the client-side application. However, server system 404 first checks whether the user has access to a requested functions based on whether the user has provided certain health data to server system 404, such as image data pertaining to a vaccination card.

In this embodiment where server system 404 checks whether a user has access to a requested function, many of the steps in process 400 are the same. One difference is that there is no step 428. Thus, there is no unlocking (triggered by the receipt of the encoded data or smart badge by client device 402) of functions on the client-side application. Instead, in this embodiment, server system 404 receives a request (e.g., a reservation request) from client device 402 and determines whether to allow the request to proceed to PAM system 406. As mentioned above, PAM system 406 may including multiple systems. For example, a different PAM system may be used for each function. one of the one or more PAM systems may be third party system. One of the one or more PAM systems may communicate with server system 404 by using an API. This determination may involve server system 404 checking an immunity database (e.g., health-access database 144) to determine whether a user/employee ID in the request is found in the immunity database (which would indicate that the user has scanned his/her health/vaccination card). If so, then server system 404 forwards the request to PAM system 406. If not, then server system 404 may notify client device 402 that the request is denied. The notification may prompt the user of client device 402 to take a picture of a health (e.g., vaccination) card, which may trigger the automatic transfer of the resulting digital image to server system 404.

This check of the immunity database may occur at any point in process 400. If the check occurs before the user/employee ID is in the immunity database, then server system 404 will deny or decline the request. If the check occurs after the user/employee ID is in the immunity database, then server system 404 may accept the request and forward it to PAM system 406.

This check of the immunity database may also involve determining whether a time period has expired or lapsed. For example, if a vaccination status is valid for nine months from receiving a vaccination, a date in the future from the vaccination date is determined and compared to the current date. If the current date is after the determined date that is after the vaccination date, then server system 404 does not forward the request to PAM system 406. Instead, server system 404 may generate and send, to client device 402, a notification that the request cannot be made at that time. Such a scenario indicates that server system 404 has not yet processed image data pertaining to a health card of the user of client device 402.

### Temporary Reservations

In an embodiment, in the context of location reservations and the server-side modification, instead of declining a reservation request (e.g., if the user/employee ID is not found in the immunity database), server system 404 may notify PAM system 406 and/or client device 402 that a temporary reservation has been made, but cannot be fulfilled until server system 404 receives a digital image of a health card pertaining to a user of client device 402. The client-side application on client device 402 may receive such a notification and store temporary reservation data that is the same as reservation data except that the reservation has a status of “temporary.” Once such a digital image of a health card is received for the user of client device 402, server system 404 notifies PAM system 406, which converts any temporary reservations (that were made for the user of client device 402) to regular (or permanent) reservations.

In an embodiment, in the context of location reservations and the unlocking of client-side functions, a client-side application can still send a reservation request even though the function is currently locked; however, the reservation request indicates that the status of the reservation is temporary. As with the server-side modification context, PAM system 406 may be configured to process temporary reservation requests similar to regular (non-temporary) reservation requests.

If a reservation has a status of “temporary,” then a regular (non-temporary) reservation request for the same physical asset at the same time can overrule the temporary reservation. However, a first temporary reservation request for a physical asset cannot be overruled by a second (subsequent) temporary reservation request for the same physical asset at the same time.

### Occupancy Check

In an embodiment, in the context of reservations of physical assets, client device 402 sends an occupancy check request to PAM system 406. The occupancy check request may pertain to a particular physical asset (e.g., room) on a particular day and time or may be general to all times on a particular day, general to all days in a longer time period (such as a week or a month), and/or general to a class of physical assets or all physical assets. For example, an occupancy check request may identify a particular room and a particular week. As another example, occupancy check request might not identify any physical asset but identifies a particular day.

In response, PAM system 406 analyzes reservation data pertaining to the requested physical asset (if any) and the requested time (if any). A default time slot (if none is specified) may be the current day or the current day plus the remaining days in a week. Examples of default lengths of a time slot may be a half hour or one hour. Based on the occupancy check and the reservation data, PAM system 406 identifies one or more available physical assets on one or more available time slots of one or more days and sends occupancy information to client device 402.

This embodiment may be part of the client-side embodiment (where the client-side application unlocks certain functions in response to receiving a smart badge) or the server-side embodiment (i.e., where server system 404 checks whether the user/employee ID is found in the immunity database).

### Examples

In the following examples, additional processes, systems, and methods are described in the context of a system for managing access to a physical area.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

A first clause is a client device, the client device including one or more processors, one or more storage media or memories storing instructions which, when executed by the one or more processors, cause locking one or more functions in an application that executes on the client device, receiving, from a remote server system, a smart badge that is associated with healthcare information, in response to receiving the smart badge, unlocking the one or more functions, and after unlocking the one or more functions and in response to user input that selects a particular function of the one or more functions, transmitting, over a computer network, a request and identification data that pertain to the particular function.

A further clause is the client device of the first clause where the particular function is a location reservation function and the request is a location reservation request to reserve a physical asset.

A further clause is the client device of the clause above where sending the location reservation request comprises sending the location reservation request to a physical access management system that is different than the remote server system.

A further clause is the client device a clause above wherein: while the location reservation function is in a locked state, location reservation requests cannot be sent to reserve any physical asset; and while the location reservation function is in an unlocked state, location reservation requests can be sent to reserve physical assets.

A further clause is the client device of the first clause wherein the smart badge is a two-dimensional code.

A further clause is the client device of the first clause wherein the identification data includes an employee identifier.

A further clause is the client device of the first clause wherein the instructions, when executed by the one or more processors, further cause, prior to unlocking the one or more functions in response to receiving second user input that selects the particular function, transmitting, over the computer network, a second request that has a status of a temporary request; and after transmitting the second request, receiving confirmation data that indicates that the temporary request has been processed and that includes an invitation to provide health status information.

A further clause is the client device of the first clause, wherein the instructions, when executed by the one or more processors, further cause, prior to unlocking the one or more functions, presenting, on a screen of the client device, a list of functions that indicate that the one or more functions are in a locked state; and in response to unlocking the one or more functions, updating the list to indicate that the one or more functions are in an unlocked state.

A further clause is the client device of the first clause, wherein the instructions, when executed by the one or more processors, further cause: in response to receiving second user input that selects a check occupancy function that is not in the one or more functions, transmitting, over the computer network, to a physical access management system, a check occupancy request.

A further clause is the client device of the first clause, wherein the instructions, when executed by the one or more processors, further cause generating digital image data and sending the digital image data to the remote server system.

A further clause is the client device of the first clause, wherein the instructions, when executed by the one or more processors, further cause: in response to determining that a user of the client device attempts to use a locked function, causing prompt data to be presented on a screen of the client device, wherein the prompt data prompts the user to take a picture of a health card.

A second clause is one or more storage media storing instructions, which, when executed by one or more processors, cause locking one or more functions in an application that executes on the client device, receiving, from a remote server system, a smart badge that is associated with healthcare information, in response to receiving the smart badge, unlocking the one or more functions, and after unlocking the one or more functions and in response to user input that selects a particular function of the one or more functions, transmitting, over a computer network, a request and identification data that pertain to the particular function.

A further clause is the storage media of the second clause where the particular function is a location reservation function and the request is a location reservation request to reserve a physical asset.

A further clause is the storage media of the further clause above where sending the location reservation request comprises sending the location reservation request to a physical access management system that is different than the remote server system.

A further clause is the storage media a clause above wherein: while the location reservation function is in a locked state, location reservation requests cannot be sent to reserve any physical asset; and while the location reservation function is in an unlocked state, location reservation requests can be sent to reserve physical assets.

A further clause is the storage media of the second clause wherein the smart badge is a two-dimensional code.

A further clause is the storage media of the second clause wherein the identification data includes an employee identifier.

A further clause is the storage media of the second clause wherein the instructions, when executed by the one or more processors, further cause, prior to unlocking the one or more functions in response to receiving second user input that selects the particular function, transmitting, over the computer network, a second request that has a status of a temporary request; and after transmitting the second request, receiving confirmation data that indicates that the temporary request has been processed and that includes an invitation to provide health status information.

A further clause is the storage media of the second clause, wherein the instructions, when executed by the one or more processors, further cause, prior to unlocking the one or more functions, presenting, on a screen of the client device, a list of functions that indicate that the one or more functions are in a locked state; and in response to unlocking the one or more functions, updating the list to indicate that the one or more functions are in an unlocked state.

A further clause is the storage media of the second clause, wherein the instructions, when executed by the one or more processors, further cause: in response to receiving second user input that selects a check occupancy function that is not in the one or more functions, transmitting, over the computer network, to a physical access management system, a check occupancy request.

A further clause is the storage media of the second clause, wherein the instructions, when executed by the one or more processors, further cause generating digital image data and sending the digital image data to the remote server system.

A further clause is the storage media of the second clause, wherein the instructions, when executed by the one or more processors, further cause: in response to determining that a user of the client device attempts to use a locked function, causing prompt data to be presented on a screen of the client device, wherein the prompt data prompts the user to take a picture of a health card.

A third clause is a method, where the method includes: locking one or more functions in an application that executes on the client device, receiving, from a remote server system, a smart badge that is associated with healthcare information, in response to receiving the smart badge, unlocking the one or more functions, and after unlocking the one or more functions and in response to user input that selects a particular function of the one or more functions, transmitting, over a computer network, a request and identification data that pertain to the particular function.

A further clause is the method of the third clause where the particular function is a location reservation function and the request is a location reservation request to reserve a physical asset.

A further clause is the method of the further clause above where sending the location reservation request comprises sending the location reservation request to a physical access management system that is different than the remote server system.

A further clause is the method a clause above wherein: while the location reservation function is in a locked state, location reservation requests cannot be sent to reserve any physical asset; and while the location reservation function is in an unlocked state, location reservation requests can be sent to reserve physical assets.

A further clause is the method of the third clause wherein the smart badge is a two-dimensional code.

A further clause is the method of the third clause wherein the identification data includes an employee identifier.

A further clause is the method of the third clause, further including, prior to unlocking the one or more functions in response to receiving second user input that selects the particular function, transmitting, over the computer network, a second request that has a status of a temporary request; and after transmitting the second request, receiving confirmation data that indicates that the temporary request has been processed and that includes an invitation to provide health status information.

A further clause is the method of the third clause, further including, prior to unlocking the one or more functions, presenting, on a screen of the client device, a list of functions that indicate that the one or more functions are in a locked state; and in response to unlocking the one or more functions, updating the list to indicate that the one or more functions are in an unlocked state.

A further clause is the method of the third clause, further including in response to receiving second user input that selects a check occupancy function that is not in the one or more functions, transmitting, over the computer network, to a physical access management system, a check occupancy request.

A further clause is the method of the third clause, further including generating digital image data and sending the digital image data to the remote server system.

A further clause is the method of the third clause, further including, in response to determining that a user of the client device attempts to use a locked function, causing prompt data to be presented on a screen of the client device, wherein the prompt data prompts the user to take a picture of a health card.

A fourth clause is a server system comprising one or more processors and one or more memories storing instructions which, when executed by the one or more processors, cause: receiving, from a first client device, a first reservation request to reserve a location for a user of the first client device, wherein the first reservation request includes a first user identifier; in response to receiving the first reservation request, determining whether the first user identifier is in a particular database; in response to determining that the first user identifier is not in the particular database, refraining from reserving a location for the user of the first client device; receiving image data; after receiving the image data: sending, to a second client device, smart badge data that is created based on the image data and that allows a user of the second client device to enter one or more physical areas; updating the particular database to include a second user identifier that is associated with the user of the second client device; receiving, from the second client device, a second reservation request to reserve a location for a user of the second client device, wherein the second reservation request includes the second user identifier; in response to receiving the second reservation request, determining whether the second user identifier is in the particular database; in response to determining that the second user identifier is in the particular database, allowing the user of the second client device to reserve a particular location.

A further clause is the server system of the fourth clause, wherein the instructions, when processed by the one or more processors, further cause: in response to determining that the first user identifier is not in the particular database, allowing the user of the first client device to temporarily reserve the location and sending, to the first client device, a notification that indicates a temporary reservation of the location and that includes an invitation to upload health data to the server system.

A further clause is the server system of the fourth clause, wherein receiving the image data comprises receiving the image data from the second client device.

A further clause is the server system of the fourth clause, wherein the image data is of a vaccination card.

A further clause is the server system of the fourth clause, wherein the smart badge data is a two-dimensional code.

A fifth clause is a storage media storing instructions which, when executed by one or more processors, cause: receiving, from a first client device, a first reservation request to reserve a location for a user of the first client device, wherein the first reservation request includes a first user identifier; in response to receiving the first reservation request, determining whether the first user identifier is in a particular database; in response to determining that the first user identifier is not in the particular database, refraining from reserving a location for the user of the first client device; receiving image data; after receiving the image data: sending, to a second client device, smart badge data that is created based on the image data and that allows a user of the second client device to enter one or more physical areas; updating the particular database to include a second user identifier that is associated with the user of the second client device; receiving, from the second client device, a second reservation request to reserve a location for a user of the second client device, wherein the second reservation request includes the second user identifier; in response to receiving the second reservation request, determining whether the second user identifier is in the particular database; in response to determining that the second user identifier is in the particular database, allowing the user of the second client device to reserve a particular location.

A further clause is the storage media of the fifth clause, wherein the instructions, when processed by the one or more processors, further cause: in response to determining that the first user identifier is not in the particular database, allowing the user of the first client device to temporarily reserve the location and sending, to the first client device, a notification that indicates a temporary reservation of the location and that includes an invitation to upload health data to the server system.

A further clause is the storage media of the fifth clause, wherein receiving the image data comprises receiving the image data from the second client device.

A further clause is the storage media of the fifth clause, wherein the image data is of a vaccination card.

A further clause is the storage media of the fifth clause, wherein the smart badge data is a two-dimensional code.

A sixth clause is a method including: receiving, from a first client device, a first reservation request to reserve a location for a user of the first client device, wherein the first reservation request includes a first user identifier; in response to receiving the first reservation request, determining whether the first user identifier is in a particular database; in response to determining that the first user identifier is not in the particular database, refraining from reserving a location for the user of the first client device; receiving image data; after receiving the image data: sending, to a second client device, smart badge data that is created based on the image data and that allows a user of the second client device to enter one or more physical areas; updating the particular database to include a second user identifier that is associated with the user of the second client device; receiving, from the second client device, a second reservation request to reserve a location for a user of the second client device, wherein the second reservation request includes the second user identifier; in response to receiving the second reservation request, determining whether the second user identifier is in the particular database; in response to determining that the second user identifier is in the particular database, allowing the user of the second client device to reserve a particular location.

A further clause is the method of the sixth clause, further including: in response to determining that the first user identifier is not in the particular database, allowing the user of the first client device to temporarily reserve the location and sending, to the first client device, a notification that indicates a temporary reservation of the location and that includes an invitation to upload health data to the server system.

A further clause is the method of the sixth clause, wherein receiving the image data comprises receiving the image data from the second client device.

A further clause is the method of the sixth clause, wherein the image data is of a vaccination card.

A further clause is the method of the sixth clause, wherein the smart badge data is a two-dimensional code.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

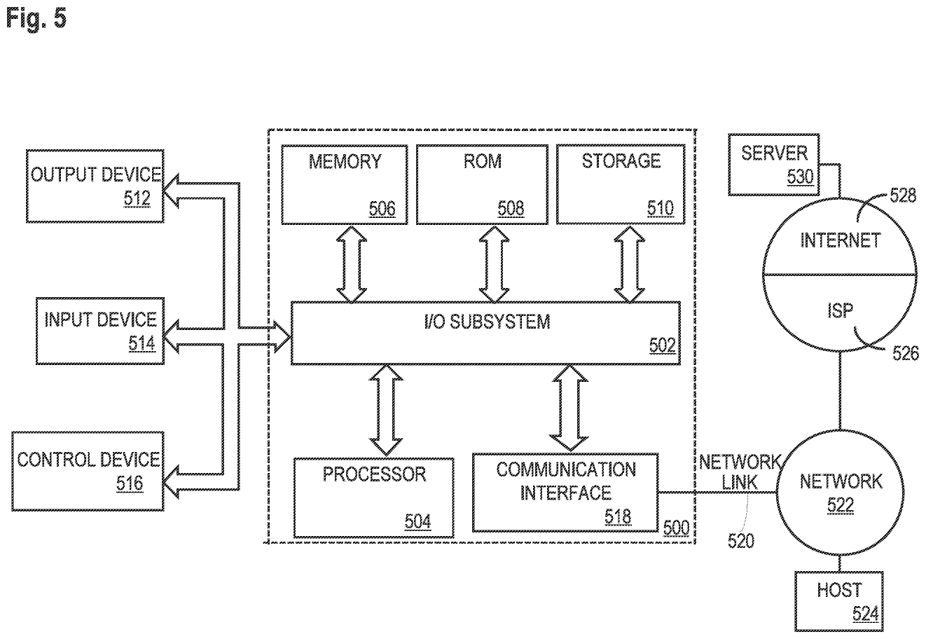

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more storage media storing instructions which, when executed by one or more processors of a client device, cause:
locking one or more functions in an application that executes on the client device;
receiving, from a remote server system, a smart badge that is associated with healthcare information;
in response to receiving the smart badge, unlocking the one or more functions;
after unlocking the one or more functions and in response to user input that selects a particular function of the one or more functions, transmitting, over a computer network, a request and identification data that pertain to the particular function.

2. The one or more storage media of claim 1, wherein:
the particular function is a location reservation function;
the request is a location reservation request to reserve a physical asset.

3. The one or more storage media of claim 2, wherein sending the location reservation request comprises sending the location reservation request to a physical access management system that is different than the remote server system.

4. The one or more storage media of claim 2, wherein:
while the location reservation function is in a locked state, location reservation requests cannot be sent to reserve any physical asset;
while the location reservation function is in an unlocked state, location reservation requests can be sent to reserve physical assets.

5. The one or more storage media of claim 1, wherein the smart badge is a two-dimensional code.

6. The one or more storage media of claim 1, wherein the identification data includes an employee identifier.

7. The one or more storage media of claim 1, wherein the instructions, when executed by the one or more processors, further cause, prior to unlocking the one or more functions:
in response to receiving second user input that selects the particular function, transmitting, over the computer network, a second request that has a status of a temporary request;
after transmitting the second request, receiving confirmation data that indicates that the temporary request has been processed and that includes an invitation to provide health status information.

8. The one or more storage media of claim 1, further comprising:
prior to unlocking the one or more functions, presenting, on a screen of the client device, a list of functions that indicate that the one or more functions are in a locked state;
in response to unlocking the one or more functions, updating the list to indicate that the one or more functions are in an unlocked state.

9. The one or more storage media of claim 1, wherein the instructions, when executed by the one or more processors, further cause:
in response to receiving second user input that selects a check occupancy function that is not in the one or more functions, transmitting, over the computer network, to a physical access management system, a check occupancy request

10. The one or more storage media of claim 1, wherein the instructions, when executed by the one or more processors, further cause:
generating digital image data and sending the digital image data to the remote server system.

11. The one or more storage media of claim 1, wherein the instructions, when executed by the one or more processors, further cause:
in response to determining that a user of the client device attempts to use a locked function, causing prompt data to be presented on a screen of the client device, wherein the prompt data prompts the user to take a picture of a health card.

12. A method comprising:
locking one or more functions in an application that executes on a client device;
receiving, from a remote server system, a smart badge that is associated with healthcare information;
in response to receiving the smart badge, unlocking the one or more functions;
after unlocking the one or more functions and in response to user input that selects a particular function of the one or more functions, transmitting, over a computer network, a request and identification data that pertain to the particular function.

13. The method of claim 12, wherein:
the particular function is a location reservation function;
the request is a location reservation request to reserve a physical asset.

14. The method of claim 12, further comprising:
prior to unlocking the one or more functions, presenting, on a screen of the client device, a list of functions that indicate that the one or more functions are in a locked state;
in response to unlocking the one or more functions, updating the list to indicate that the one or more functions are in an unlocked state.

15. The method of claim 12, further comprising:
generating digital image data and sending the digital image data to the remote server system.

16. A server system comprising:
one or more processors; and
one or more memories storing instructions which, when processed by the one or more processors, cause:
receiving, from a first client device, a first reservation request to reserve a location for a user of the first client device, wherein the first reservation request includes a first user identifier;
in response to receiving the first reservation request, determining whether the first user identifier is in a particular database;
in response to determining that the first user identifier is not in the particular database, refraining from reserving a location for the user of the first client device;
receiving image data,
after receiving the image data:
sending, to a second client device, smart badge data that is created based on the image data and that allows a user of the second client device to enter one or more physical areas;
updating the particular database to include a second user identifier that is associated with the user of the second client device;
receiving, from the second client device, a second reservation request to reserve a location for a user of the second client device, wherein the second reservation request includes the second user identifier;
in response to receiving the second reservation request, determining whether the second user identifier is in the particular database;
in response to determining that the second user identifier is in the particular database, allowing the user of the second client device to reserve a particular location.

17. The server system of claim 16, wherein the instructions, when processed by the one or more processors, further cause:
in response to determining that the first user identifier is not in the particular database, allowing the user of the first client device to temporarily reserve the location and sending, to the first client device, a notification that indicates a temporary reservation of the location and that includes an invitation to upload health data to the server system.

18. The server system of claim 16, wherein receiving the image data comprises receiving the image data from the second client device.

19. The server system of claim 16, wherein the image data is of a vaccination card.

20. The server system of claim 16, wherein the smart badge data is a two-dimensional code.
